(19) United States
(12) Patent Application Publication
(10) Pub. No.: US 2019/0130015 A1
(43) Pub. Date: May 2, 2019

(54) SYSTEMS AND METHODS FOR CATEGORIZING DATA TRANSACTIONS

(71) Applicant: SAP SE, Walldorf (DE)

(72) Inventors: Lu Zhang, Seattle, WA (US); Joshua Manoj, Bellevue, WA (US)

(73) Assignee: SAP SE, Walldorf (DE)

(21) Appl. No.: 15/794,592

(22) Filed: Oct. 26, 2017

(51) Int. Cl. G06F 17/30; G06N 7/00; G06N 5/02

(52) U.S. Cl. CPC G06F 17/30598; G06Q 10/10; G06N 5/022; G06N 7/005

(57) ABSTRACT

In one embodiment, the present disclosure pertains to systems and method for categorizing data transactions. In one embodiment, string type names are received from different users to describe different types of transactions. The string type names are preprocessed, tokenized, converted to values, and processed by a machine learning algorithm to generate likelihoods. The likelihoods may correspond to internal type categories of a common software platform, for example.

### CROSS REFERENCE TO RELATED APPLICATIONS

The present disclosure contains subject matter related to the subject matter in the following concurrently filed patent application: U.S. patent application Ser. No. ______ (Attorney Docket No. 000005-065400US), entitled “Systems and Methods for Categorizing Data Transactions.”

### BACKGROUND

The present disclosure relates to computing and data processing, and in particular, to systems and methods for categorizing data transactions.

The widespread adoption of using computers for data processing has led to number of challenges. One challenge stems from the wide variety of representations real world entities may take on when represented in electronic form. For example, in a cloud computer system, different clients/customers may set up their cloud data to match unique internal systems or each particular client. For instance, string type names (e.g., expense type names) may be dramatically different for different customers. For telecom expenses, one customer may have an expense type name of “telephone,” another customer may have an expense type name of “phones and recurring,” and yet another customer may have an expense type name of “Verizon/TMobile,” for example. In a single cloud computing system designed to process and manage such expenses across many clients, reconciling unique type names across a multitude of transaction categories over numerous clients can present a programming and data processing challenge.

### SUMMARY

Embodiments of the present disclosure pertain to systems and method for categorizing data transactions. In one embodiment, the present disclosure pertains to systems and method for categorizing data transactions. In one embodiment, string type names are received from different users to describe different types of transactions. The string type names are preprocessed, tokenized, converted to values, and processed by a machine learning algorithm to generate likelihoods. The likelihoods may correspond to internal type categories of a common software platform, for example.

The following detailed description and accompanying drawings provide a better understanding of the nature and advantages of the present disclosure.

### BRIEF DESCRIPTION OF THE DRAWINGS

FIG. 1 illustrates an architecture for categorizing data transactions according to one embodiment.

FIG. 2 illustrates an example application for categorizing data transactions according to one embodiment.

FIG. 3 illustrates a process for categorizing data transactions according to an embodiment.

FIG. 4 illustrates using user selected results in a training set according to an example embodiment.

FIG. 5 illustrates using associated fields for data categorization according to an example embodiment.

FIG. 6 illustrates an example process for data categorization using related documents according to an embodiment.

FIG. 7 illustrates another example using related fields of existing data for data categorization according to an embodiment.

FIG. 8 illustrates replacing word patterns with predefined pattern tokens according to an example embodiment.

FIG. 9 illustrates hardware of a special purpose computing machine configured according to the above disclosure.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

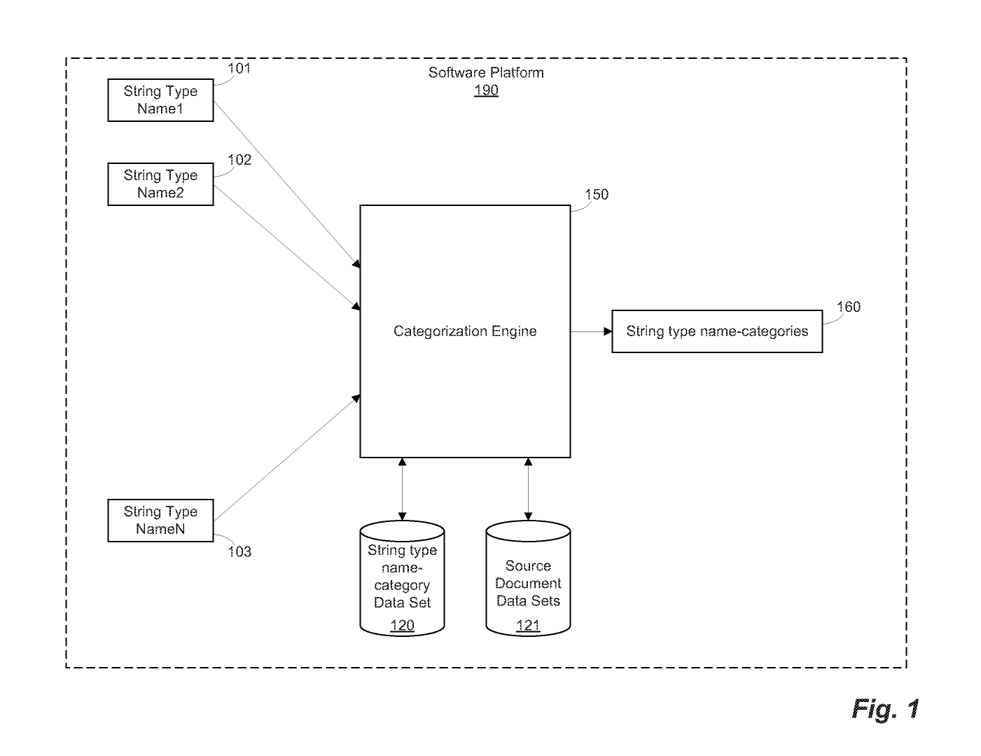

FIG. 1 illustrates an architecture for generating normalized master data to one embodiment. Features and advantages of the present disclosure include reconciling different user defined type names (e.g., strings, or string type names) for numerous fields across many different users into common categories for use in a cloud computer system, for example. Embodiments of the present disclosure may allow many customers to specify their own names for various “types” of transactions, such as expenses for travel, telecom, lodging, etc. . . . in common software platform 190, which may be a cloud based computing system, for example. The software platform 190 supporting the different types may automatically determine which common categories the user defined “types” should be associated with. As illustrated in FIG. 1, a first user may define a type name for a particular transaction type (e.g., a user defined “Expense Type Name” such as “Verizon/TMoble”). Since the user defined type names are typically strings comprising multiple words, they are referred to herein as “string type names.” Multiple different users may define multiple string type names 101-103 for a wide range of transaction types to be processed by software platform 190.

Features and advantages of the present disclosure include a categorization engine 150 that receives the different user defined string type names. Embodiments of the disclosure may preprocess the string type names, convert to numeric values, and generate likelihoods that each string type name should be associated with one of a plurality of type categories used by software platform 190 to process and manage user transactions. For example, once the different user defined string type names are received, the system may tokenize the string type names to produce a plurality of tokens. Each token may correspond to one word in a particular string type name, for example. The tokens may then be converted to values, and the values may be used to generate likelihoods (aka probabilities) that correspond to different common categories. In one embodiment, likelihoods may be generated from a product of each value and a corresponding weight, wherein weights are generated from a training set comprising a plurality of tokenized string type names having a known type category of a plurality of type categories used internally by system 190. In other words, the system uses the likelihoods to map user defined string type names to internal common type categories (e.g., Verizon/TMobile and “Phone Charges” to “Telecom”). The likelihoods each correspond to one of the plurality of type categories, so the type category having the highest corresponding likelihood may be associated with the user defined string type name, for example. For example, if a string type name is “5555-PHONE CHARGES AT HOTEL,” for example, the likelihoods for example internal common type categories may be: ‘LODGN’—0.55168718682997775, ‘TELEC’—0.44831281317002214, ‘ACCNT’—0.0, etc. . . .

In one embodiment, weights and training data sets may be stored in storage 120. As described in more detail below, generating the weights determining values for tokenized string type names in a training set and converting each known internal type category to one of the internal common type categories values. Accordingly, a training set includes values corresponding to the values of the tokens derived from the input string type names, and further includes values corresponding to particular categories. In other words, the training set comprises training inputs and results. Weights may be derived from the training set and used to determine the likelihood that each received string type name corresponds to particular type category in the system.

Finally, after the probabilities are generated, particular embodiments may associate the user defined string type names with the type categories based on the likelihoods as illustrated at 160. In one embodiment described in more detail below, internal common type categories having the TopN highest likelihoods (e.g., Top 3) may be presented to a user for selection, for example, and the selected string type name and internal common type category are used in the training set for subsequent analysis.

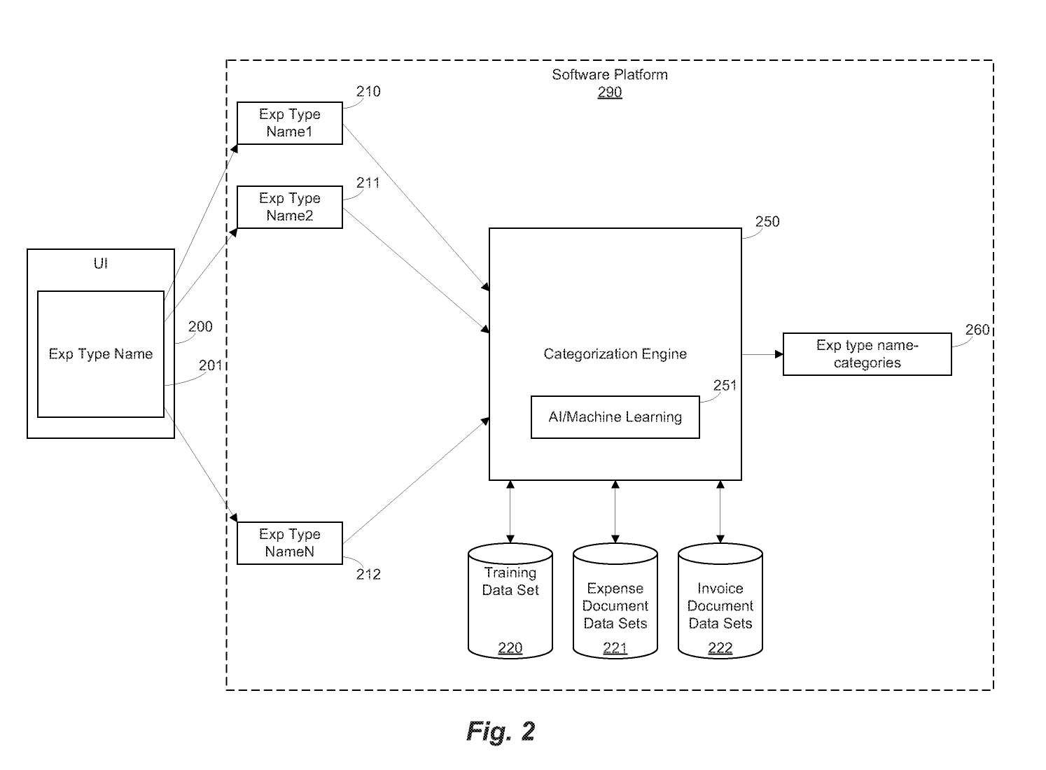

FIG. 2 illustrates an example application for categorizing data transactions according to one embodiment. In this example, different users of software platform may use a user interface (UI) 200 to access and setup their accounts. In this example, different users may enter different “Expense Type Names.” While the following examples illustrate techniques for associating different expense type names with different internal common expense type categories, it is to be understood that the techniques described herein may be used to map different string type names to particular internal common type categories.

As mentioned above, different customers may want to map expenses to particular buckets or type names that are used within their organizations. When an employee submits an expense report or when an invoice is received, a variety of different expenses may be associated with different expense type names specific to each company for example. These company specific type names may be voluminous and may vary from company to company. Embodiments described herein may allow these distinct type names to be mapped to common categories in a cloud system 290, for example. For example, one customer may have configured an expense type name “telephone,” another customer may have configured an expense type name “Verizon/TMobile,” and a third customer may have configured an expense type name “phones and recurring.” In system 290, all of these expenses may be automatically categorized as “Telecom” during a “setup” or “onboarding” process. Later, as customers fill out expense reports over time, other data fields in expense reports, invoices or other related documents may be used to associate certain type names that may not have been associated during onboarding, for example. Accordingly, embodiments of the disclosure allow users to add additional related information (e.g., vendor information) so that the mapping to common categories becomes faster and more accurate.

When the system receives a string type name, such as an expense type name, it may first preprocess the string. Preprocessing may include cleansing, stemming, and tokenizing, for example. For example, if the string type name is “5555-PHONE CHARGES AT HOTEL,” then the first step may be to keep only the characters and remove all other characters (e.g., remove numbers and special chars). The next step may include stemming or lemmatizing (e.g., run, running, runner=“run”; phones=“phone”). Tokenizing may split the string into single tokens (e.g., words/between spaces). Using the above example expense type name, the process produces the following results:

Input: “5555-PHONE CHARGES AT HOTEL”

Cleansing: PHONE CHARGES AT HOTEL

Stemming/Lemmatizing: PHONE CHARGE AT HOTEL

Tokenize (individual words): S1=PHONE, S2=CHARGE, S3=AT, S4=HOTEL

Embodiments of the disclosure may apply the tokenized string type name input to an artificial intelligence (AI)/machine learning algorithm 251 to associate the string type name input with one of the internal common type categories. First, the tokenized words from the expense type name may be converted to values. In one example embodiment, the tokens Si may be converted to values by determining a “term frequency-inverse document frequency” (herein, “tf-idf”) value for each token. Term frequency-inverse document frequency (“tf-idf”) is a numerical statistic that is intended to reflect how important a word is to a document in a collection or corpus. A tf-idf value may increase with the number of times a word appears in the document decrease with the frequency of the word. Accordingly, words like “the” and “a” and “an” can be eliminated by their frequency and limited impact on the meaning of the content, for example. Tf-idf can be expressed as (#times word appears)×(#docs/#times word appears). Accordingly, tokenized words in each expense category may form a vector S={Si}, i=1 . . . n, where each element Si may be transformed into a tf-idf value. The input expense type name value vector can then be combined with a weight vector w={wi}, i=1 . . . n, to produce a linear combination of weighted values si*wi. These weighted values may be operated on by a loss function, such as a modified Huber loss function to produce probabilities. In one embodiment described in more detail below, different known internal common type categories (e.g., internal expense categories, such as “Telecom” and “Lodging”) may have corresponding weight vectors. Thus, the input expense type name value vector, S, may be combined with each set of weights, and the result operated on by a loss function to produce corresponding sets of probabilities—one for each unique internal category. A loss function may be an algorithm for minimizing loss, for example. An example loss function is a Huber loss function or modified Huber loss function, for example. The category specific weight vector producing the highest probability may be deemed the best internal category for that input. For example, the input expense type name value vector, S, may be applied to 3 different weights for internal type categories “Telecom” (wt), “Lodging” (wl), and “Meals” (wm):

Huber(S*wt)=L1; Huber(S*wl)=L2; and Huber(S*wm)=L3,

“Huber” refers to the modified Huber loss function, including the following parameters: penalty, alpha, and n-iterations. Accordingly, L1, L2, and L3 are the highest likelihoods resulting from the modified Huber loss functions for the weight set associated with the “Telecom” category, the weight set associated with the “Lodging” category, and the weight set associated with the “Meals” category, respectively. In one example implementation, the modified Huber loss function may use the following parameter values: penalty=L2, Alpha=1e-3, n_iteration=7. In the example above, the results may be as follows: L1 (Telcom)=0.44831; L2 (Lodging)=0.5517; etc. Thus, the highest probability is that the input expense type name is for the internal type category, “Lodging.”

One challenge with categorizing string names of the kind analyzed here is that the input strings can be very domain specific, where the language and quasi-English used to describe the particular type names may mean something particular or have more relevance in the particular domains (abbreviations, project codes, etc. . . . ) but have very little meaning outside the domain. Accordingly, the particular choices of cleansing, stemming, and tokenizing, etc. . . . described herein produce improved results for certain embodiments for associating internal categories to the variety of string type name inputs provided (e.g., characters, abbreviations, codes, etc.).

In order to determine likelihoods, the system may generate weights from a training set maintained in storage 220. The training set may comprise sample string type names (e.g., expense type names) mapped to internal common type categories (e.g., internal expense categories), for example. A corpus of such (input_string:category) pairs may be converted into weight vectors as described above. First, strings are tokenized as above. Next, term frequency-inverse document frequency (tf-idf) values are determined for each of the plurality of tokenized string type names in the training set. For example, if the training set includes “Office Supply,” then the sting is converted to tokens (S1=Office, S2=Supply) and each token is converted to a tf-idf value, for example, to produce a training vector (T1={tf-idf1, tf-idf2}). Next, each each known type category may be converted to one of a plurality of type categories values. For example, if there are 4 total categories (e.g., Office, Meals, Lodging, Travel), then each may be associated with a numeric value (Office=1, Meals=2, Lodging=3, Travel=4). If the training vector for “Office Supply” had an associated result value of “Office,” then the training vector may be as follows: (T1,R1)={tf-idf1, tf-idf, 0, . . . 0, 1}, where each unique word in the training set corpus is associated with a particular field and zeros (0's) are used for any words in the corpus that are not in a particular training vector. As another example, if the training set includes “Office Meeting,” and the result is “Meals,” then the training vector/result pair is (T2,R2)=(tf-idf1, 0, tf-idf3, 0, . . . , 2), where tf-idf1 is the tf-idf for the word “Office,” tf-idf2 is the tf-idf for the word “Supply,” and tf-idf3 is the tf-idf for the word “Meeting.” Accordingly, the training vector may have a number of fields equal to the number of unique words in the training set. The training vectors may be combined to form a training matrix, T, having a number of rows, N, equal to the total number (input_string:category) pairs (or training sets), and a number of columns, M, equal to the total number of words in the training set.

In one example embodiment, a plurality of sets of weights are generated based on setting a particular one of the plurality of type category values to one (1) and the others to zero (0), and then determining the weights for each set of weights based on determining a loss function (e.g., a modified Huber loss function), for example. For example, the above NxM training matrix of (input_string:category) pairs may be as follows: T=[T:R]_{N×M}, where each row includes tf-idf values and a numeric value representing one of the categories. If training matrix T is mapped to L matrices, where each of the L matrices sets a different one of the numeric category values to 1 and the rest to 0, there will be L matrices of Ti=[T:(0,1)], i=1 . . . L. For example, in the simplified case of 3 categories (e.g., Travel, Lodging, Telecom), there would be 3 weight sets generated from T1=[T:(0,1)], where any instance of “Travel” in the Result column is set to 1 and all others are set to 0, T2=[T:(0,1)], where any instance of “Lodging” is set to 1 and all others are set to 0, and T3=[T:(0,1)], where any instance of “Telecom” is set to 1 and all others are set to 0.

The following is an example of code for determining likelihoods according to one embodiment:

clf = Pipeline([

(‘tfidf’, CountVectorizer(

```
  tokenizer=LemmaTokenizer( ),
  min_df=1
  )),
```

(‘clf’, SGDClassifier(

loss=‘modified_huber’,
penalty=‘l2’,
alpha=1e−3,
n_iter=7))])

The following are two sample string type name inputs and output likelihoods:
Input: “555-Phone Charges at Hotels”
Result: (‘Successful prediction.’, 0.12543388660053292, [(‘LODGN’, 0.55168718682997775), (‘TELEC’, 0.44831281317002214), (‘ACCNT’, 0.0), (‘ADVTG’, 0.0), (‘AIRFR’, 0.0), (‘CARXX’, 0.0), (‘COMPU’, 0.0), (‘CONSL’, 0.0), (‘DONAT’, 0.0), (‘ENTER’, 0.0), (‘FACLT’, 0.0), (‘FEESD’, 0.0), (‘FINAN’, 0.0), (‘GIFTS’, 0.0), (‘GRTRN’, 0.0), (‘INSUR’, 0.0), (‘JANTR’, 0.0), (‘LEGAL’, 0.0), (‘OFFIC’, 0.0), (‘OSUPP’, 0.0), (‘OTHER’, 0.0), (‘PRNTG’, 0.0), (‘PROFS’, 0.0), (‘RENTL’, 0.0), (‘SHIPG’, 0.0), (‘STAFF’, 0.0), (‘SUBSC’, 0.0), (‘TRADE’, 0.0), (‘TRAIN’, 0.0), (‘UTLTS’, 0.0)])
Input: “T-mobile”
Result: (‘Successful prediction.’, 0.14911299003513356, [(‘TELEC’, 0.83009169384072801), (‘OTHER’, 0.097256457463770374), (‘ACCNT’, 0.03630111090409123), (‘SHIPG’, 0.016407203616054897), (‘PRNTG’, 0.016175366326276711), (‘STAFF’, 0.0037681678490788717), (‘ADVTG’, 0.0), (‘AIRFR’, 0.0), (‘CARXX’, 0.0), (‘COMPU’, 0.0), (‘CONSL’, 0.0), (‘DONAT’, 0.0), (‘ENTER’, 0.0), (‘FACLT’, 0.0), (‘FEESD’, 0.0), (‘FINAN’, 0.0), (‘GIFTS’, 0.0), (‘GRTRN’, 0.0), (‘INSUR’, 0.0), (‘JANTR’, 0.0), (‘LEGAL’, 0.0), (‘LODGN’, 0.0), (‘OFFIC’, 0.0), (‘OSUPP’, 0.0), (‘PROFS’, 0.0), (‘RENTL’, 0.0), (‘SUBSC’, 0.0), (‘TRADE’, 0.0), (‘TRAIN’, 0.0), (‘UTLTS’, 0.0)])

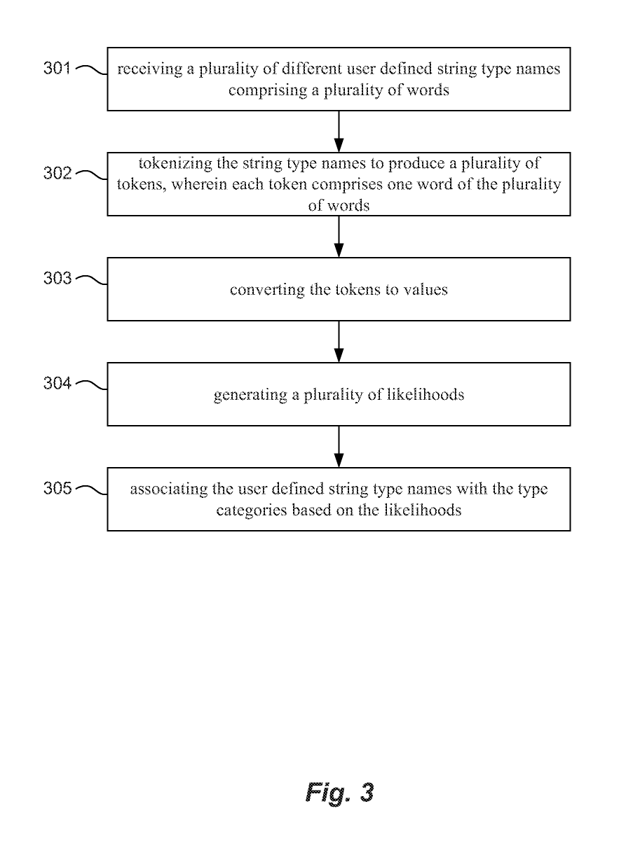

FIG. 3 illustrates a process for categorizing data transactions according to an embodiment. For example, at 301, a plurality of different user defined string type names comprising a plurality of words may be received in a categorization engine. At 302, the string type names may be tokenized to produce a plurality of tokens, wherein each token comprises one word of the plurality of words. At 303, the tokens may be converted to values. At 304, a plurality of likelihoods may be generated from a product of each value and a corresponding weight, wherein weights are generated from a training set comprising a plurality of tokenized string type names having a known type category of a plurality of type categories. The likelihoods may each correspond to one of the plurality of type categories, for example. At 305, the user defined string type names may be associated with the type categories based on the likelihoods.

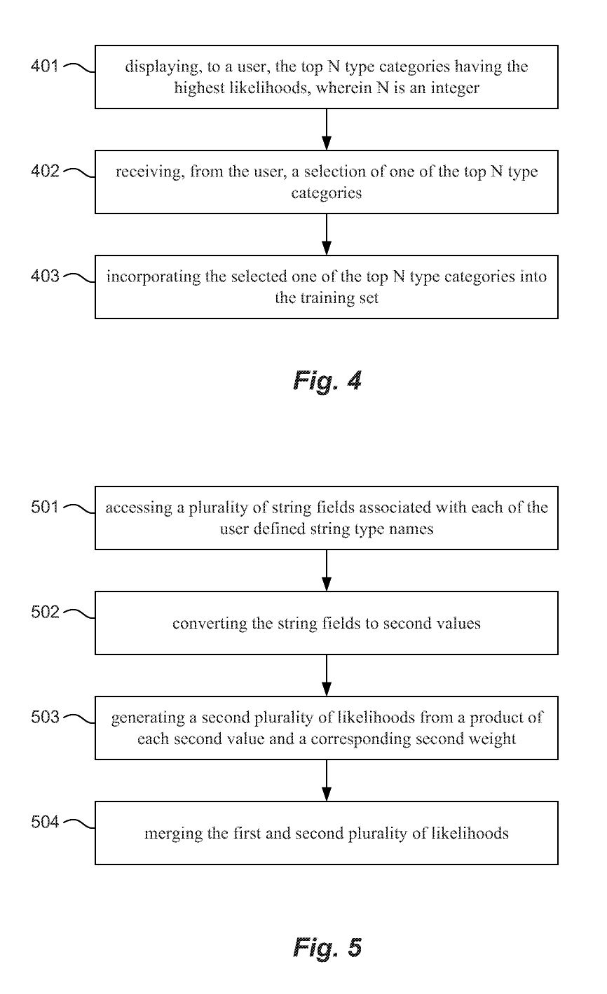

FIG. 4 illustrates using user selected results in a training set according to an example embodiment. As mentioned above, certain embodiments may include selection of most likely results by a user and incorporation of the selected result back into the training set. For example, at 401, the top N (where N is an integer) type categories having the highest likelihoods may be displayed to a user (e.g., in user interface 200. At 402, a selection of one of the top N type categories is received from the user. At 403, the selected one of the top N type categories may be incorporated into the training set.

### Aggregated Related Document Data

Features and advantages of some embodiments may include accessing data in related documents to perform data categorization. FIG. 5 illustrates using associated fields for data categorization according to an example embodiment. In one embodiment, a plurality of string fields associated with each of the user defined string type names may be accessed at 501. Referring again to the example in FIG. 2, documents having fields with “expense type name” strings may have other associated fields that may be analyzed to improve the data categorization process, for example. At 502, the associated string fields may be converted to second values. At 503, a second plurality of likelihoods may be generated from a product of each second value and a corresponding second weight (e.g., from a second weight set). At 504, the first and second plurality of likelihoods may be merged.

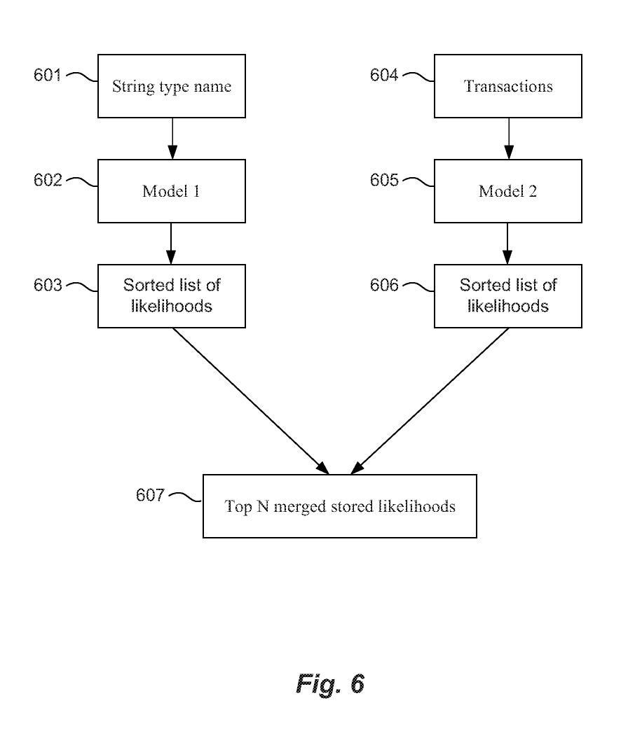

FIG. 6 illustrates an example process for data categorization using related documents according to an embodiment. As illustrated in FIG. 2, related documents may include expense reports and/or invoices for determining internal type categories for expense type names, for example. For example, a particular expense report submitted by an employee may include expenses with expense type names set to “Hotels and Lodging” by the particular user. Such expenses may have related information (e.g., strings) that may be used to determine internal categories (e.g., Hotels and Lodging→Travel), for example. Similarly, particular invoices may include expenses with expense type names set to “Hotels and Lodging” by the particular user. Such invoice expenses may have related information (e.g., strings) that may be used to determine internal categories (e.g., Hotels and Lodging→Travel), for example. In a system that aggregates documents such as expense reports and invoices from numerous different customers across numerous different employees for each customer, embodiments of the present disclosure may advantageously be used to automatically determine internal category types across all customers and users, for example. Such a process may be run against existing customers who have an available corpus of transaction data, for example.

Referring again to FIG. 6, string type names may be analyzed at 601 and supplied to a first model 602 (e.g., an AI or machine learning model) to produce likelihoods at 603. This process may be similar to the process described above with reference to FIGS. 1-3, for example. However, in one embodiment, transactions related to the string type names may be analyzed at 604 using another model 605 to produce likelihoods 606. For example, if two expense reports contain expenses categorized internally as “Hotels and Lodging,” and both further have a “Description” Field, then the descriptions may be analyzed independently using another machine learning model to improve the automatic categorization of the expenses. Particular string type names in various transactions such as invoices and expense reports may have numerous fields related to the string type names, for example, such as “descriptions,” “costs,” “vendors,” etc. . . . Such transactional information may be stored in a database, for example, with expense type names for invoices and expense reports having associated database fields for descriptions, costs, vendors, and potentially other useful information for determining internal expense categories, for example.

The following example illustrates how invoices with expense type names and associated fields may be categorized according to an embodiment. First, expense type names for a corpus of invoices may be retrieved from a database, for example, and processed using a machine learning model (e.g., processing “555-Phone Charges at Hotel” as described above). However, each expense type name field for each invoice may have related fields that may be stored as associated fields in a database, for example. Example fields associated with expense type name may include “vendor”, ‘description”, “quantity”, and “total cost”, for example. In some embodiments, these fields may be used to determine type categories as well using independent models for each field. For example, the “vendor” field may be analyzed, tokenized, converted to values, weighted, and used to determine likelihoods that particular descriptions correspond to particular type categories (e.g., “Travel”, etc. . . . ).

The following is an example description of how a “vendor” field associated with an “expense type name” field in an invoice is processed according to an embodiment. First, the invoices may be stored in relational tables of a database. A query may be sent to the database to retrieve expense type names and related vendors, for example. The query may be configured to group related vendors by expense type name and entity (e.g., a particular company account). The following is an example query the may be performed:
Select distinct (ID, type, aggr(vendor)) from transaction_table group by type
   The above query returns results as a table, where each row of the table comprises a first field for storing a unique string type name (“type”) and at least one second field for storing aggregated string information. An ID field may be a unique ID of each customer account, for example. Here, the aggregated string information may include a plurality of vendor strings from numerous transactions associated with each of the unique string type names. For example, the following are examples of expense type names and aggregated vendors in an example results table:

TABLE 1

| | ExpType | |
|---|---|---|
| ID | Name | Vendors |
| 1 | Hotel Charges | Hyatt, Marriott, W Hotels, Marriott, . . . , Hyatt |
| 2 | Cell Phones | AT&T, TMobile, Verizon, AT&T, AT&T, Verizon, |
| | | . . . Sprint |

Table 1 above illustrates aggregation of related fields by string type names according to some embodiments. From the table it can be seen that each unique string type name (here, “expense type names”) is in one row under a particular field or column, and all vendors associated with the particular string type name are aggregated into a second field (here, “vendors”). In other words, for each “hotel charges” expense type name, the query retrieves all vendors having that expense type name and aggregates such vendors into a single field, “vendors.”

Next, the vendors, for example, may be tokenized, converted to a value (e.g., using tf-idf), weighted, and then operated on by a machine learning algorithm to determine likelihoods that the particular vendors result in a particular internal expense category. The weights may be generated from a training set of (vendor:category) values, for example. Also, as described above, multiple different weight sets may be used corresponding to multiple different categories, where one category result is set to one (1) and the others zero (0) to produce likelihoods corresponding to each category (as described above).

In other embodiments, multiple related categories to the string type names may be used to map string type names specified by particular user accounts/companies to internal type categories on a common software platform. In the following example, “descriptions”, “average costs”, and “vendors” may all be used to determine categorization of particular “expense type names,” for example. The following is an example query and query result:
Select distinct (id, type, aggr(description), avg(cost), aggr(vendor)) from transaction_table group by id, type

### Result:

TABLE 2

| | ExpType | |
|---|---|---|
| ID | Name | Descriptions |
| 1 | Hotel Charges | description1, . . . description N |
| 2 | Cell Phones | description1, . . . description M |

. . .

| Ave | |
|---|---|
| Costs | Vendors |
| 100 | Hyatt, Marriott, W Hotels, Marriott, . . . , Hyatt |
| 735 | AT&T, TMobile, Verizon, AT&T, AT&T, Verizon, . . . Sprint |

where ID is a unique customer ID, Expense Type Name is the customer specific type name for expenses, descriptions 1-N and 1-M are aggregated strings in the description field, average costs are an average of values in the cost field associated with each particular expense type name, and vendors are the aggregated vendor lists for each particular expense type name. The two example rows of Table 2 have been divided into two parts above for illustrative purposes, but represent five fields of one example table with two rows of data.

As mentioned above, each of the fields above associated with the “Expense Type Name” field may be independently analyzed, tokenized, converted to values, weighted, and processed with machine learning algorithms to produce likelihoods. In one embodiment, a vendor field, description field, and average cost field are converted to values and weighted together. Further in some embodiments, a value based on a function of a count of unique vendors and count of transactions may be weighted together with the above mentioned fields. For example, a quotient of a count of distinct vendors to a count of total transactions (distinct vendor count/total transactions count) may indicate whether there are few vendors (lower value) or many vendors (higher value), for example, to improve the categorization process. Average cost, which is returned by the query, may be converted to a value as follows: −1 if negative, log₁₀N if positive within amount N, for example.

Additionally, in some embodiments, word patterns may be identified in string fields, such as descriptions, an mapped to tokens. For example, first and last names may be identified as a “name” word pattern. If a “name” word pattern is identified in a string field, the string field having the name may be mapped to a predefined pattern token (e.g., “NAMETOKEN”). The predefined pattern token may then be converted to a value, for example, such as a predetermined tf-idf value. Advantages of pattern identification and tokenization include reducing noise in the system from insignificant word patterns, such as names, for example.

In one embodiment, the likelihoods resulting from processing a string type name alone and the likelihoods resulting from processing the related fields may be weighted before being merged. For example, in one embodiment, a standard deviation is determined for the likelihoods generated from the string type name alone, and a second standard deviation is determined for the likelihoods generated from the related fields (e.g., vendor, description, cost, etc. . . . ). Determining standard deviation, which is used to quantify the amount of variation or dispersion of a set of data values, is illustrated as follows: s=sqrt(sum(xi−x̂)²/(N−1)), where xi is the ith likelihood, x̂ is the mean likelihood, and N is the number of likelihoods in the result. Each likelihood result set may be weighted by the standard deviation, for example. Thus, if a result set based on the Expense Type Name along produced likelihoods R1=[Lodging=0.6, Travel=0.3, and Telecom=0.09, etc. . . . ] with a standard deviation=Std1, and a second result set based on vendors, descriptions, and costs produced likelihoods R2=[Travel=0.4, Lodging=0.3, Telecom=0.1, etc. . . . ] with a standard deviation of=Std2, then the following results may be ranked and merged: R1*Std1 and R2*Std2.

In the one embodiment, merged top probabilities may not sum up to one, but the order shows its likelihood. Below are is an example of a tab separated result including entity_id (clientID), expense_type_name (clients category name), top1_prediction (Category), count (#transactions of that expense type for that company), merged_top_predictions (List of results). Additionally, sample string type names and related fields are shown, including description, aggregated vendors and a vendor_count (how many times the vendor associated with the particular expense type name for particular client appeared in the data set).

### Example Dataset:

Descriptions=[‘Datasite’, ‘Data room pages processed’, ‘Financial, tax and valuation due diligence’, ‘Consulting on Thoratec acquistion’, ‘Data room services’] [aggr vendors/vendor counts]=[(‘MERRILL COMMUNICATIONS, LLC’, 13), (‘ERNST & YOUNG LLP’, 10), (‘DELOITTE TRANSACTIONS & BUSINESS’, 4), (‘E*TRADE FINANCIAL CORPORATE’, 3), (‘DELOITTE TAX LLP’, 2)]

### Example Result:

ID=P0002897on8c ExpenseTypeName=“z_Prepaid Acquisition Expense” (transaction count=14450) Top1=FINAN Count of Top1=46 [(Internal Category, Likelihood)]=[(‘FINAN’, 0.53870492091464095), (‘OTHER’, 0.46129507908535888), (‘ACCNT’, 0.18069053034758811), (‘CONSL’, 0.035344615595061156), (‘STAFF’, 0.0)]

While the above example of related data illustrates using invoice data related to an expense type name, it is to be understood that other related data may be used. For example, as mentioned above, expense reports may have expense type names and related data fields. The following illustrates a model for an example expense report to produce likelihoods that can be merged with likelihoods from the expense type name alone, for example: Vendor (a list of vendors from transactions, “Amazon, Inc.”, “T-mobile”, “KPMG”); Total cost (−1 if negative amount, log10N if positive amount N); If car rental days (1 if avg>0, 0 if not available; from a column in Expense for recording car rental days, mostly null for non-car related categories); If lodging days (1 if avg>0, 0 if not available; from a column in Expense for recording lodging days if available, mostly null for non-lodging categories); If attendee (1 if avg>0, 0 if not available; from a column in Expense for recording numbers of attendees); Add reviewed vendor/keyword vectors to match with (e.g., add “uber, lyft, cab” for “Ground transportation” category, “banking, audit” for “Financial services”; may be retrieved from the most frequent vendors/keywords and reviewed).

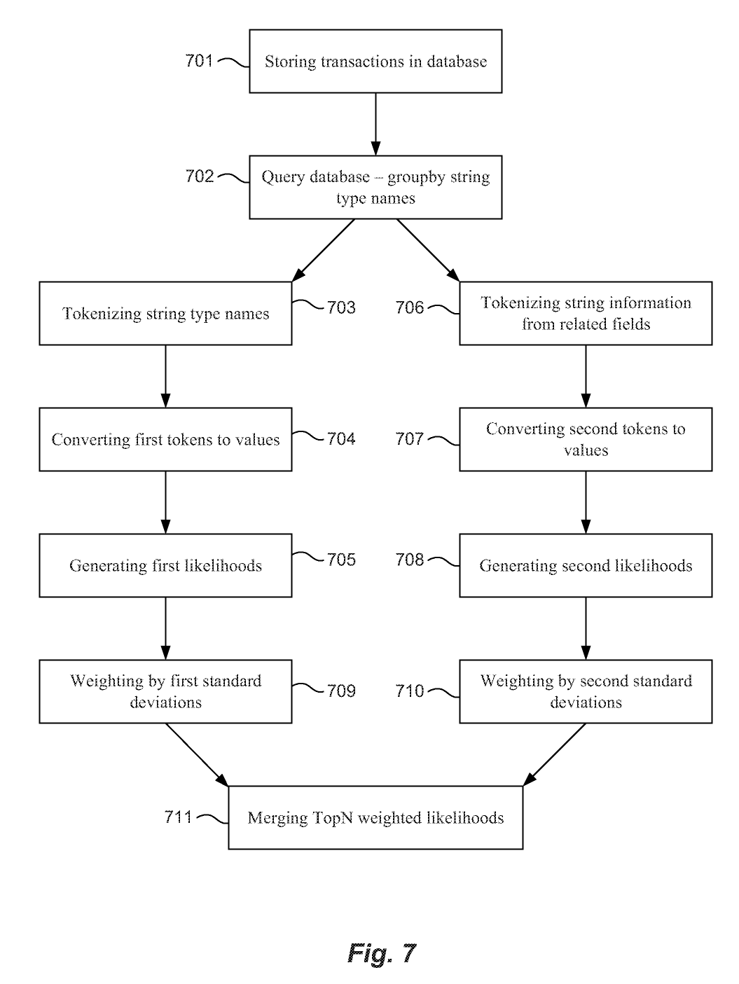

FIG. 7 illustrates another example using related fields of existing data for data categorization according to an embodiment. For example, at 701, a plurality of transactions may be stored in a database. The transactions may include a first field and a plurality of related fields, where the first field includes different user defined string type names comprising a plurality of first words (e.g., expense type name=“5555-PHONE CHARGES AT HOTEL”). The related fields may comprise string information about the transactions comprising a plurality of second words (e.g., a description and/or vendor information). At 702, a query is sent to the database. The query returns a query result comprising the plurality of related fields grouped by string type names, for example. For example, the query result may be stored in a table, where each row of the table comprises a first field for storing a unique string type name and one or more second fields for storing aggregated string information. The aggregated string information may include a plurality of strings from a plurality of transactions associated with each of the unique string type names.

Embodiments of the present disclosure may advantageously process string type names with one model and related data using another model. String type names are processed at 703-709. At 703, the string type names may be tokenized to produce a plurality of first tokens, where each first token comprises one word of the plurality of first words, for example. At 704, the first tokens are converted to first values, such as tf-idf values, for example. At 705, a plurality of first likelihoods are generated from a product of each first value and a corresponding first weight. The first weights may be generated from a first training set comprising a plurality of tokenized string type names having a known type category (e.g., on a software system supporting multiple customer accounts) of a plurality of type categories. The first likelihoods may each correspond to one of the plurality of type categories as illustrated above, for example. At 709, the first likelihoods may be weighted by determining a standard deviation, for example.

String information related to or associated with the string type names may be processed at 706-708. For example, at 706 string information in related string fields may be tokenized into second tokens. At 707, the second tokens are converted to second values, such as tf-idf values or other values described herein, for example, where each second token comprises one word of the plurality of second words. In one embodiment, additional values may be determined and used by a machine learning algorithm to categorize data. For example, in one embodiment, the system may determine, for each string type name, a first count C1 of unique strings in a first field of the related fields (e.g., a count of unique vendors in an aggregated vendor field). Additionally, the system may determine a second count C2 of a number of transactions for each string type name (e.g., how many transactions had an expense type name of “Hotel Expense” and how many had an expense type name of “Office Supplies”). In some embodiments, at least one value may be a function of the first count and the second count. For example, one of the values may be a quotient of the first count and the second count (e.g., C1/C2).

At 708, second likelihoods are generated from a product of each second value and a corresponding second weight. The second weights may be generated from a second training set comprising a plurality of tokenized string information having a known internal type category (e.g., Travel, Telecom, Lodging). The second likelihoods may each correspond to one of the plurality of type categories as in step 705, for example. At 710, the second likelihoods may be weighted by determining a standard deviation, for example.

At 711, the first and second likelihoods are merged. In one embodiment, merging includes selecting the N highest likelihoods from the weighted first and second likelihoods, where N is an integer, for example. Finally, the system may associate the user defined string type names with the type categories based on the merged likelihoods.

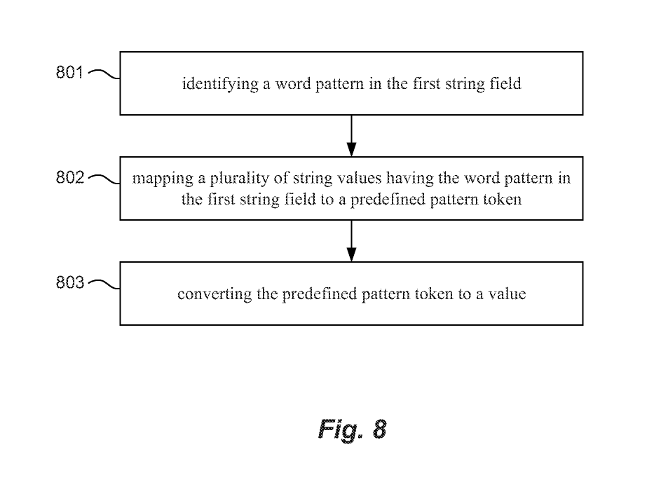

FIG. 8 illustrates replacing word patterns with predefined pattern tokens according to an example embodiment. As illustrated in the examples above, some embodiments may replace word patterns with a pattern token (e.g., all first and last name patterns with “NAMETOKEN”). As illustrated in FIG. 8, embodiments may identify a word pattern in a string field at 801. At 802, a plurality of string values having the word pattern in the first string field are mapped to a predefined pattern token. At 803, the predefined pattern token is converted to a value for use in a machine learning algorithm. As mentioned above, converting word patterns, such as names, can reduce noise in the machine learning algorithm and improve the accuracy of the results, for example.

### Hardware

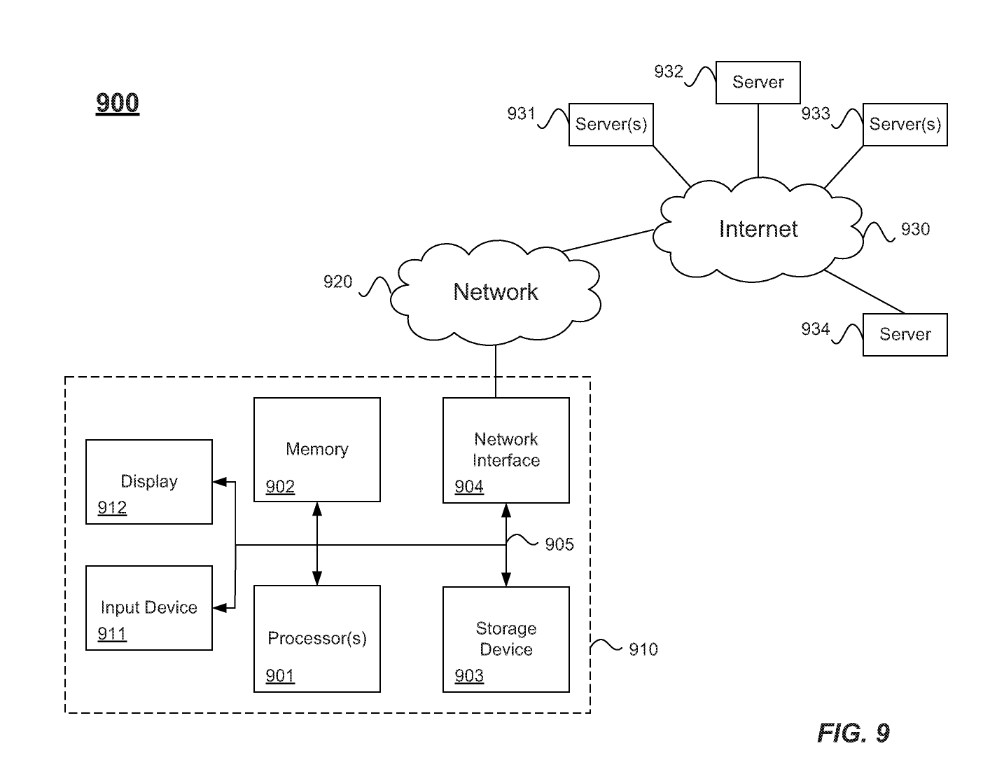

FIG. 9 illustrates hardware of a special purpose computing machine configured according to the above disclosure. The following hardware description is merely one example. It is to be understood that a variety of computers topologies may be used to implement the above described techniques. An example computer system 910 is illustrated in FIG. 9. Computer system 910 includes a bus 905 or other communication mechanism for communicating information, and one or more processor(s) 901 coupled with bus 905 for processing information. Computer system 910 also includes a memory 902 coupled to bus 905 for storing information and instructions to be executed by processor 901, including information and instructions for performing some of the techniques described above, for example. Memory 902 may also be used for storing programs executed by processor(s) 901. Possible implementations of memory 902 may be, but are not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 903 may include source code, binary code, or software files for performing the techniques above, for example. Storage device 903 and memory 902 are both examples of non-transitory computer readable storage mediums.

Computer system 910 may be coupled via bus 905 to a display 912 for displaying information to a computer user. An input device 911 such as a keyboard, touchscreen, and/or mouse is coupled to bus 905 for communicating information and command selections from the user to processor 901. The combination of these components allows the user to communicate with the system. In some systems, bus 905 represents multiple specialized buses for coupling various components of the computer together, for example.

Computer system 910 also includes a network interface 904 coupled with bus 905. Network interface 904 may provide two-way data communication between computer system 910 and a local network 920. Network 920 may represent one or multiple networking technologies, such as Ethernet, local wireless networks (e.g., WiFi), or cellular networks, for example. The network interface 904 may be a wireless or wired connection, for example. Computer system 910 can send and receive information through the network interface 904 across a wired or wireless local area network, an Intranet, or a cellular network to the Internet 930, for example. In some embodiments, a browser, for example, may access data and features on backend software systems that may reside on multiple different hardware servers on-prem 931 or across the Internet 930 on servers 932-935. One or more of servers 932-935 may also reside in a cloud computing environment, for example.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method comprising:
storing, in a database, a plurality of transactions, the transactions comprising a first field and a plurality of related fields, wherein the first field comprising different user defined string type names comprising a plurality of first words, and wherein the plurality of related fields comprise string information about the transactions comprising a plurality of second words;
tokenizing the string type names to produce a plurality of first tokens, wherein each first token comprises one word of the plurality of first words;
tokenizing the string information to produce a plurality of second tokens, wherein each second token comprises one word of the plurality of second words;
converting the first tokens to first values;
converting the second tokens to second values;
generating a plurality of first likelihoods from a product of each first value and a corresponding first weight, wherein first weights are generated from a first training set comprising a plurality of tokenized string type names having a known type category of a plurality of type categories, and wherein the first likelihoods each correspond to one of the plurality of type categories;
generating a plurality of second likelihoods from a product of each second value and a corresponding second weight, wherein second weights are generated from a second training set comprising a plurality of tokenized string information having the known type category of the plurality of type categories, and wherein the second likelihoods each correspond to one of the plurality of type categories;
merging the first and second likelihoods; and
associating the user defined string type names with the type categories based on the merged likelihoods.

2. The method of claim 1 further comprising sending a query to the database, the query returning a query result comprising the plurality of related fields grouped by string type name.

3. The method of claim 2 further comprising storing the query result in a table, wherein each row of the table comprises a first field for storing a unique string type name and one or more second fields for storing aggregated string information, the aggregated string information comprising a plurality of strings from a plurality of transactions associated with each of the unique string type names.

4. The method of claim 2 further comprising:
determining, for each string type name, a first count of unique strings in a first field of the related fields; and
determining a second count of a number of transactions for each string type name,
wherein at least one of the second values is a function of the first count and the second count.

5. The method of claim 4 wherein the at least one of the second values is a quotient of the first count and the second count.

6. The method of claim 1 wherein merging the first and second likelihoods comprises weighting first and second likelihoods.

7. The method of claim 6 wherein the weighting of the first likelihoods is a first standard deviation for the first likelihoods, and the weighting of the second likelihoods is a second standard deviation for the second likelihoods, the merging further comprising selecting N highest likelihoods from the weighted first and second likelihoods.

8. A computer system comprising:
one or more processors; and
non-transitory machine-readable medium coupled to the one or more processors, the non-transitory machine-readable medium storing a program executable by at least one of the processors, the program comprising sets of instructions for:
storing, in a database, a plurality of transactions, the transactions comprising a first field and a plurality of related fields, wherein the first field comprising different user defined string type names comprising a plurality of first words, and wherein the plurality of related fields comprise string information about the transactions comprising a plurality of second words;
tokenizing the string type names to produce a plurality of first tokens, wherein each first token comprises one word of the plurality of first words;
tokenizing the string information to produce a plurality of second tokens, wherein each second token comprises one word of the plurality of second words;
converting the first tokens to first values;
converting the second tokens to second values;
generating a plurality of first likelihoods from a product of each first value and a corresponding first weight, wherein first weights are generated from a first training set comprising a plurality of tokenized string type names having a known type category of a plurality of type categories, and wherein the first likelihoods each correspond to one of the plurality of type categories;
generating a plurality of second likelihoods from a product of each second value and a corresponding second weight, wherein second weights are generated from a second training set comprising a plurality of tokenized string information having the known type category of the plurality of type categories, and wherein the second likelihoods each correspond to one of the plurality of type categories;
merging the first and second likelihoods; and
associating the user defined string type names with the type categories based on the merged likelihoods.

9. The computer system of claim 8 the program further comprising sets of instructions for sending a query to the database, the query returning a query result comprising the plurality of related fields grouped by entity and string type name.

10. The computer system of claim 9 the program further comprising sets of instructions for storing the query result in a table, wherein each row of the table comprises a first field for storing a unique string type name and one or more second fields for storing aggregated string information, the aggregated string information comprising a plurality of strings from a plurality of transactions associated with each of the unique string type names.

11. The computer system of claim 9 the program further comprising sets of instructions for:
determining, for each string type name, a first count of unique strings in a first field of the related fields; and
determining a second count of a number of transactions for each string type name,
wherein at least one of the second values is a function of the first count and the second count.

12. The computer system of claim 11 wherein the at least one of the second values is a quotient of the first count and the second count.

13. The computer system of claim 8 wherein merging the first and second likelihoods comprises weighting first and second likelihoods.

14. The computer system of claim 13 wherein the weighting of the first likelihoods is a first standard deviation for the first likelihoods, and the weighting of the second likelihoods is a second standard deviation for the second likelihoods, the merging further comprising selecting N highest likelihoods from the weighted first and second likelihoods.

15. A non-transitory machine-readable medium storing a program executable by at least one processing unit of a computer, the program comprising sets of instructions for:
storing, in a database, a plurality of transactions, the transactions comprising a first field and a plurality of related fields, wherein the first field comprising different user defined string type names comprising a plurality of first words, and wherein the plurality of related fields comprise string information about the transactions comprising a plurality of second words;
tokenizing the string type names to produce a plurality of first tokens, wherein each first token comprises one word of the plurality of first words;
tokenizing the string information to produce a plurality of second tokens, wherein each second token comprises one word of the plurality of second words;
converting the first tokens to first values;
converting the second tokens to second values;
generating a plurality of first likelihoods from a product of each first value and a corresponding first weight, wherein first weights are generated from a first training set comprising a plurality of tokenized string type names having a known type category of a plurality of type categories, and wherein the first likelihoods each correspond to one of the plurality of type categories;
generating a plurality of second likelihoods from a product of each second value and a corresponding second weight, wherein second weights are generated from a second training set comprising a plurality of tokenized string information having the known type category of the plurality of type categories, and wherein the second likelihoods each correspond to one of the plurality of type categories;
merging the first and second likelihoods; and
associating the user defined string type names with the type categories based on the merged likelihoods.

16. The computer system of claim 15 the program further comprising sets of instructions for sending a query to the database, the query returning a query result comprising the plurality of related fields grouped by entity and string type name.

17. The computer system of claim 16 the program further comprising sets of instructions for storing the query result in a table, wherein each row of the table comprises a first field for storing a unique string type name and one or more second fields for storing aggregated string information, the aggregated string information comprising a plurality of strings from a plurality of transactions associated with each of the unique string type names.

18. The computer system of claim 16 the program further comprising sets of instructions for:
determining, for each string type name, a first count of unique strings in a first field of the related fields; and
determining a second count of a number of transactions for each string type name,
wherein at least one of the second values is a function of the first count and the second count.

19. The computer system of claim 18 wherein the at least one of the second values is a quotient of the first count and the second count.

20. The computer system of claim 15 wherein merging the first and second likelihoods comprises weighting first and second likelihoods, and wherein the weighting of the first likelihoods is a first standard deviation for the first likelihoods, and the weighting of the second likelihoods is a second standard deviation for the second likelihoods, the merging further comprising selecting N highest likelihoods from the weighted first and second likelihoods.
